(19) United States
(12) Patent Application Publication
(10) Pub. No.: US 2011/0141403 A1
(43) Pub. Date: Jun. 16, 2011

(54) LIGHT-EMITTING MODULE UNIT, LIGHT GUIDE UNIT, BACKLIGHT UNIT AND LIQUID CRYSTAL DISPLAY DEVICE

(75) Inventors: Katsuhiko Kishimoto, Osaka-shi (JP); Masamitsu Kobayashi, Osaka-shi (JP); Daisuke Takeda, Osaka-shi (JP)

(73) Assignee: SHARP KABUSHIKI KAISHA, Osaka-shi, Osaka (JP)

(21) Appl. No.: 13/054,813

(22) PCT Filed: May 7, 2009
(86) PCT No.: PCT/JP2009/058612

§ 371 Date: Jan. 19, 2011

(30) Foreign Application Priority Data
Jul. 31, 2008 (JP) 2008-197279

(51) Int. Cl. G02F 1/13357; F21V 21/00; F21V 7/04

(52) U.S. Cl. 349/65; 362/382; 362/611; 349/62

(57) ABSTRACT

In an LED module (MJ), a recessed portion (DH) is formed by hollowing at least a part of a region of a non-mounting substrate surface (51B) with respect to the other parts, and the region is positioned under an LED (52).

### TECHNICAL FIELD

The present invention relates to a light-emitting module unit, a light guide unit, a backlight unit and a liquid crystal display device.

### BACKGROUND ART

In general, in a liquid crystal display device including a non-light-emitting liquid crystal display panel, a backlight unit that supplies light to the liquid crystal display panel is also included. There are various types of light sources that are used in backlight units. For example, in a backlight unit disclosed in patent document 1, an LED (light-emitting diode) is used as its light source.

The LED is mounted on a mounting substrate. Specifically, the LED that is mounted on the mounting substrate and the mounting substrate constitute an LED module (light-emitting module), and light from the LED module passes through a plurality of optical sheets and reaches a liquid crystal display panel.

In this type of LED module, heat resulting from light emission of the LED remains in the LED itself and the mounting substrate. The heat degrades the LED and the mounting substrate. Hence, as shown in the cross-sectional view of FIG. 16, the LED module mj is attached via attachment screws 106 to the frame fm of the backlight unit (a unit in which the mounting substrate 151, the LED 152 and the frame fm are integrally formed is also referred to as a light-emitting module unit mu).

In this type of configuration, as shown in FIG. 17 illustrating arrows indicating heat dissipation paths, the heat is dissipated through the attachment screws 106 to the frame fm. Moreover, the mounting substrate 151 includes a wiring line for heat dissipation (heat dissipation wiring line 102H); when the LED 152 is in contact with the heat dissipation wiring line 102H, the heat is also dissipated through the heat dissipation wiring line 102H. Thus, the heat does not remain in the LED 152 and the mounting substrate 151, and the degradation is unlikely to occur.

### RELATED ART DOCUMENT

### Patent Document

Patent document 1: JP-A-2007-311561

### DISCLOSURE OF THE INVENTION

### Problems to be Solved by the Invention

Since high image quality and high brightness have recently been required in liquid crystal display images, backlight units need to supply light of relatively high brightness to liquid crystal display panels. In order to achieve such supply, the LED 152 emits light of high brightness; the amount of heat is increased accordingly. In this case, it is impossible to sufficiently dissipate the heat left in the LED 152 and the mounting substrate 151 only through the attachment screws 106 and the heat dissipation wiring line 102H.

The present invention is designed in the view of the foregoing. An object of the present invention is to provide a light-emitting module unit or the like that can sufficiently dissipate heat emitted by a light-emitting element even when the light-emitting element emits a relatively large amount of heat.

### Means for Solving the Problem

A light-emitting module unit includes a light-emitting element, a mounting substrate and a frame. The light-emitting element is an element that emits light and is mounted on the mounting substrate. The mounting substrate in which the light-emitting element is mounted on a mounting substrate surface that is one of opposite substrate surfaces of the mounting substrate includes a recessed portion formed by hollowing at least a part of a region of a non-mounting substrate surface that is the other of the opposite substrate surfaces with respect to the non-mounting substrate, and the region is positioned under the light-emitting element. The frame includes a support surface supporting the mounting substrate and a projection portion projecting from the support surface to fill the recessed portion and make contact with the mounting substrate.

In general, the light-emitting element emits light to produce heat. Hence, heat remains in the light-emitting element itself and the mounting substrate on which the light-emitting element is mounted. However, a part of the non-mounting substrate surface, positioned under the light-emitting element, is a recessed portion, and furthermore, the projection portion of the frame fills the recessed portion and thus the mounting substrate and the frame are in contact with each other. Hence, the light-emitting element and the frame are significantly closer to each other even through the mounting substrate. Therefore, although the heat remains in the light-emitting element and the mounting substrate, the heat is dissipated through the projection portion to the frame, with the result that the light-emitting element and the mounting substrate are reliably cooled.

The recessed portion is preferably tapered toward the bottom of the recessed portion.

In this configuration, the recessed portion is formed in the shape of, for example, a frustum. In the recessed portion, a wall surface joining the bottom of the recessed portion directly below the light-emitting element extends outward toward its entrance. Hence, the wall surface of the recessed portion is increased in area as compared with, for example, the wall surface of a recessed portion that is formed in the shape of a column Consequently, the area of a portion of the mounting substrate that is in contact with the frame is increased, and thus the heat that remains in the light-emitting element and the mounting substrate is more easily dissipated.

Preferably, the projection portion is tapered toward an end of the projection portion, and the recessed portion and the projection portion are in intimate contact with each other.

In this configuration, since the recessed portion and the projection portion are in intimate contact with each other with no gap therebetween, the heat that remains in the light-emitting element and the mounting substrate is efficiently dissipated through the projection portion to the frame.

Preferably, the mounting substrate includes a heat dissipation wiring line in contact with the light-emitting element, and the heat dissipation wiring line is exposed to the recessed portion.

In this configuration, although the heat dissipation wiring line exposed from the recessed portion is positioned directly below the light-emitting element and thus heat is relatively easily left, the heat dissipation wiring line is exposed to air or the projection portion. Hence, heat is highly efficiently dissipated. Therefore, the light-emitting element and the mounting substrate are efficiently cooled with the heat dissipation wiring line exposed to air or the projection portion.

A main substrate that forms a base body of the mounting substrate preferably has a multi-layer structure.

In this configuration, the mounting substrate reliably has a rigidity equal to or more than a predetermined rigidity and is prevented from being bent due to the recessed portion.

Openings that penetrate the mounting substrate are preferably formed in areas adjacent to the recessed portion.

This is because, in this configuration, outside air that flows through the openings cools the light-emitting element from both sides thereof.

Preferably, attachment portions formed of a heat dissipation material are fitted into the openings, and the mounting substrate is fixed to the frame with the attachment portions.

In this configuration, the heat that remains in the light-emitting element and the mounting substrate is dissipated to the frame through the attachment portions that dissipate heat. Hence, the number of heat dissipation paths is increased, and the heat that remains in the light-emitting element and the mounting substrate is dissipated.

According to one aspect of the present invention, there is also provided a light guide unit including: the light-emitting module unit described above; and a light guide plate that receives light from the light-emitting element. In the light guide unit, the light guide plate is fixed to the light-emitting module with the attachment portions.

In particular, preferably, an equal or greater number of light guide plates than the number of light-emitting elements are included and are arranged to form a substrate. More specifically, preferably, in the light guide unit, the light guide plate includes: a light receiving surface that receives light from the light-emitting element; a light emitting surface that is one of two surfaces between which the light receiving surface is sandwiched and that emits light; and a bottom surface having the light receiving surface sandwiched between the light emitting surface and the bottom surface, the light guide plate is tapered and wedge-shaped by changing a distance between the light emitting surface and the bottom surface, and the light guide plates are arranged in a matrix.

According to another aspect of the present invention, there is also provided a backlight unit including: the light guide unit described above; and an optical sheet that receives light guided by the light guide plate. According to another aspect of the present invention, there is also provided a liquid crystal display device including: the backlight unit; and a liquid crystal display panel that receives light from the backlight unit.

### Advantages of the Invention

According to the present invention, a part of a non-mounting substrate surface, positioned under a light-emitting element, is a recessed portion, and a projection portion of a frame is fitted into the recessed portion. Thus, heat that remains in the light-emitting element and the mounting substrate is dissipated to the frame, and consequently, the light-emitting element and the mounting substrate are not degraded due to the heat.

### BRIEF DESCRIPTION OF DRAWINGS

FIG. 1 An enlarged exploded perspective view of a portion of a light guide unit in a liquid crystal display device of FIG. 13;

FIG. 2 A cross-sectional view taken along line B-B′ viewed in the direction of arrows in FIG. 1;

FIG. 3 A cross-sectional view of the light guide unit completed by attaching an LED module and a light guide plate with attachment screws to a frame (a cross-sectional direction is a cross-sectional direction along line B-B′ viewed in the direction of arrows in FIG. 1);

FIG. 4 A cross-sectional view illustrating arrows that indicate heat dissipation paths in the light guide unit of FIG. 3;

FIG. 5 A cross-sectional view of a light guide unit different from that of FIG. 3;

FIG. 6 An enlarged cross-sectional view of the light guide unit of FIG. 3;

FIG. 7 An exploded cross-sectional view of a light guide unit different from that of FIG. 2;

FIG. 8 A cross-sectional view of a light guide unit different from those of FIGS. 3 and 5;

FIG. 9 A cross-sectional view illustrating arrows that indicate heat dissipation paths in the light guide unit of FIG. 8;

FIG. 10 An enlarged cross-sectional view of the light guide unit of FIG. 8;

FIG. 11 An exploded cross-sectional view of a light guide unit different from those of FIGS. 2 and 7;

FIG. 12 An enlarged cross-sectional view of the light guide unit of FIG. 11 completed by attaching an LED module and a light guide plate with attachment screws to a frame;

FIG. 13 An exploded perspective view of a liquid crystal display device;

FIG. 14 A cross-sectional view of the liquid crystal display device (a cross-sectional direction is a cross-sectional direction along line A-A′ viewed in the direction of arrows in FIG. 13);

FIG. 15A A front view of an LED including a blue light emitting chip, green light emitting chips and red light emitting chips;

FIG. 15B A front view of an LED in which light from the blue light emitting chip passes through a filter of a fluorescent member;

FIG. 16 A cross-sectional view of a conventional liquid crystal display device; and

FIG. 17 A cross-sectional view of the liquid crystal display device illustrating arrows that indicate heat dissipation paths in FIG. 16.

### BEST MODE FOR CARRYING OUT THE INVENTION

### First Embodiment

A first embodiment will be described below with reference to the accompanying drawings. For convenience, hatching, member symbols and the like may be omitted; in this case, other drawings should be referenced. In the drawings, a black circle refers to a direction perpendicular to the plane of the figure.

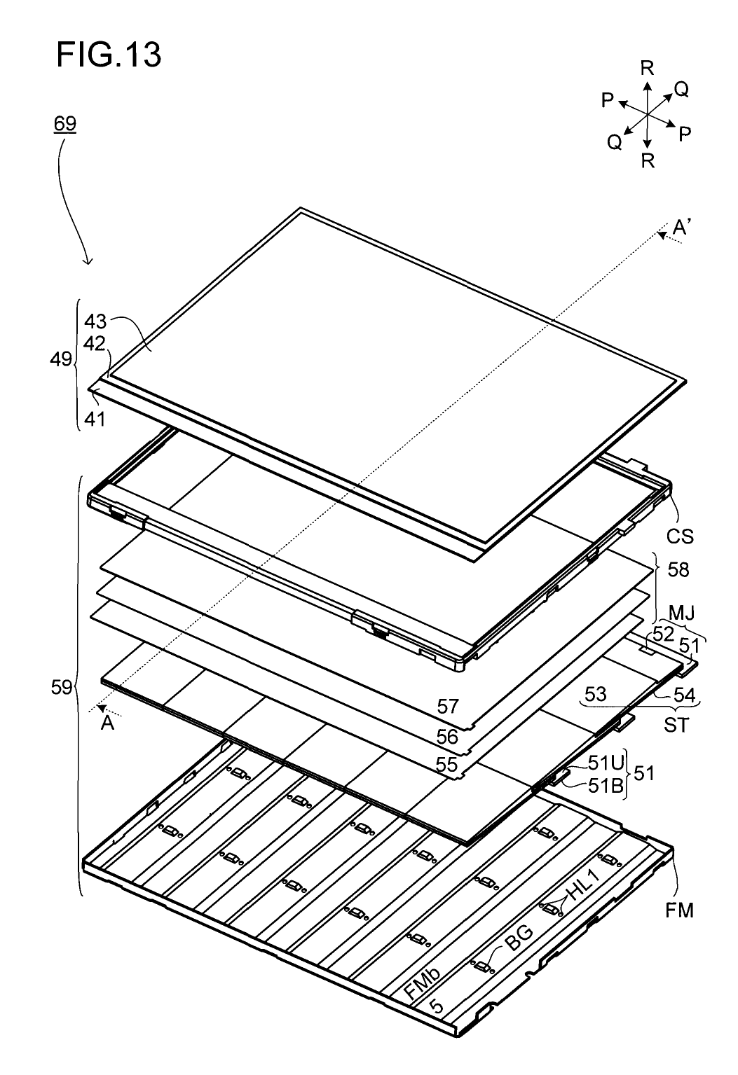

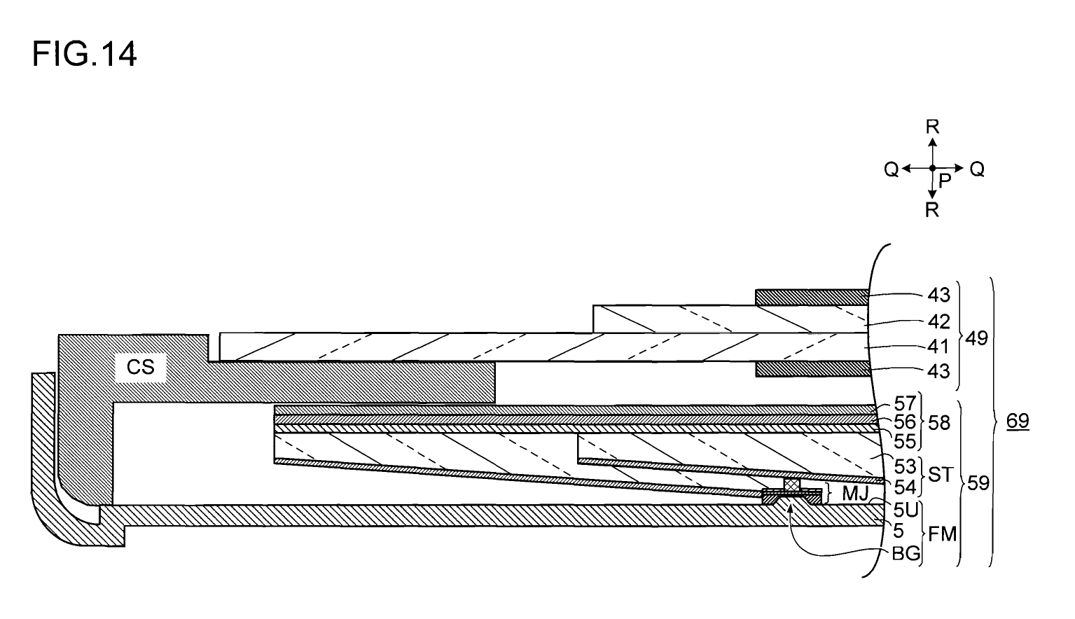

The exploded perspective view of FIG. 13 and the cross-sectional view of FIG. 14 show a liquid crystal display device 69 (a cross-sectional direction of FIG. 14 is a cross-sectional direction along line A-A′ viewed in the direction of arrows in FIG. 13). As shown in these figures, the liquid crystal display device 69 includes a liquid crystal display panel 49 and a backlight unit 59.

The liquid crystal display panel 49 is obtained by adhering an active matrix substrate 41 containing switching elements such as TFTs (thin film transistor) to an opposite substrate 42 opposite the active matrix substrate 41 with a seal member (not shown). Then, liquid crystal (not shown) is injected into a gap between both the substrates 41 and 42 (polarization films 43 are attached such that the active matrix substrate 41 and the opposite substrate 42 are sandwiched between the polarization films 43).

The backlight unit 59 applies light to the non-light-emitting liquid crystal display panel 49. Specifically, the liquid crystal display panel 49 receives the light (backlight) from the backlight unit 59 to achieve a display function. Hence, when the light from the backlight unit 59 can be evenly applied to the entire surface of the liquid crystal display panel 49, the display quality of the liquid crystal display panel 49 is improved.

The backlight unit 59 described above includes an LED module (light-emitting module) MJ, a light guide plate set ST, a diffusion sheet (optical sheet) 55, prism sheets (optical sheets) 56 and 57, an internal chassis CS and a frame FM.

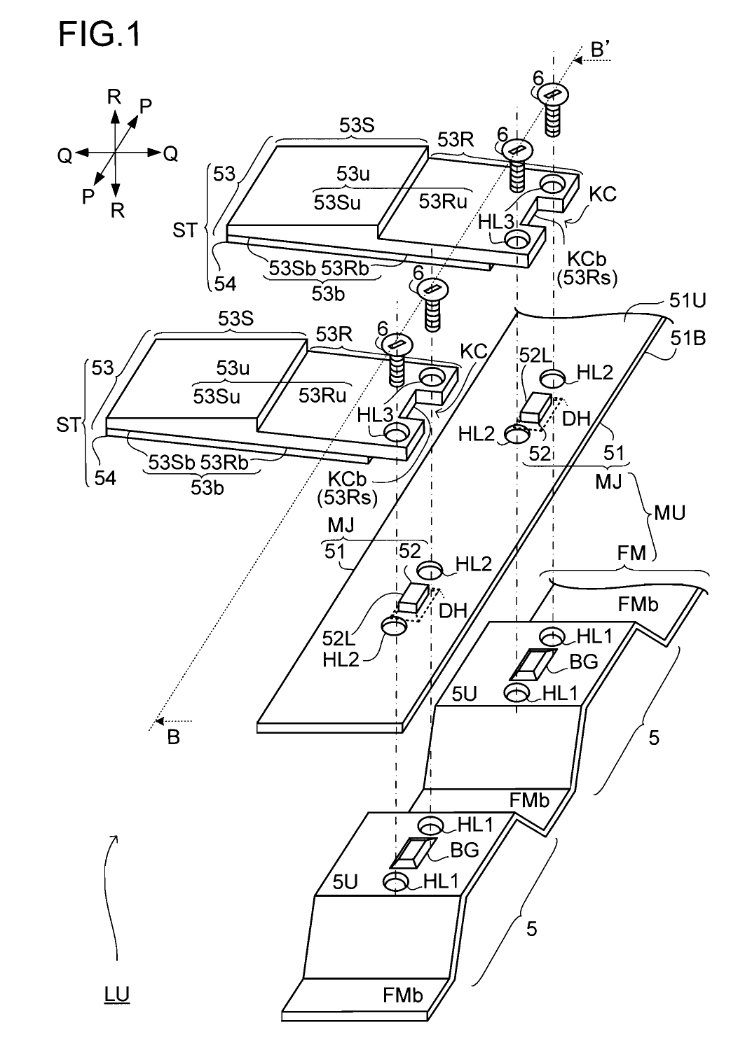

The LED module MJ is a module that emits light; as shown in FIG. 1 that is a partially enlarged exploded perspective view, the LED module MJ includes a mounting substrate 51 and an LED (light-emitting diode) 52 that receives current by being mounted on an electrode (not shown) formed on the mounting substrate surface 51U of the mounting substrate 51 and that emits light.

The LED module MJ preferably includes a plurality of LEDs (light-emitting elements, spot light sources) 52 so as to ensure a sufficient amount of light, and furthermore, the LEDs 52 are preferably aligned. For convenience, part of the LEDs 52 are only shown in the drawings (in the following description, the direction in which the LEDs 52 are aligned is referred to as an alignment direction P).

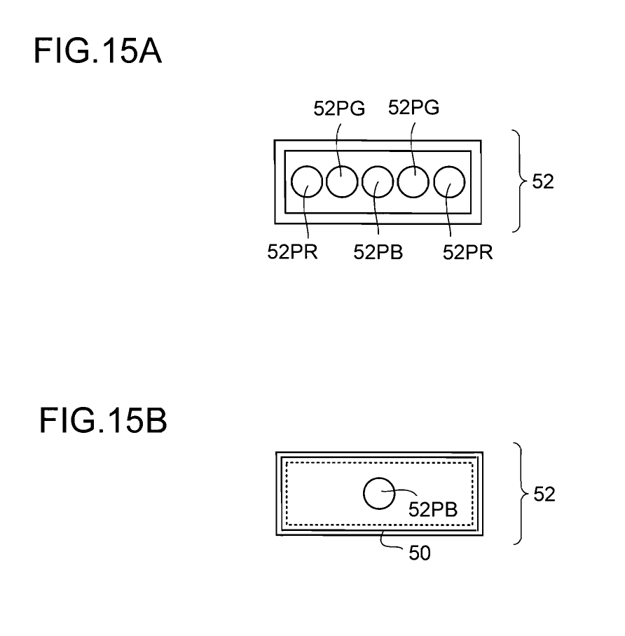

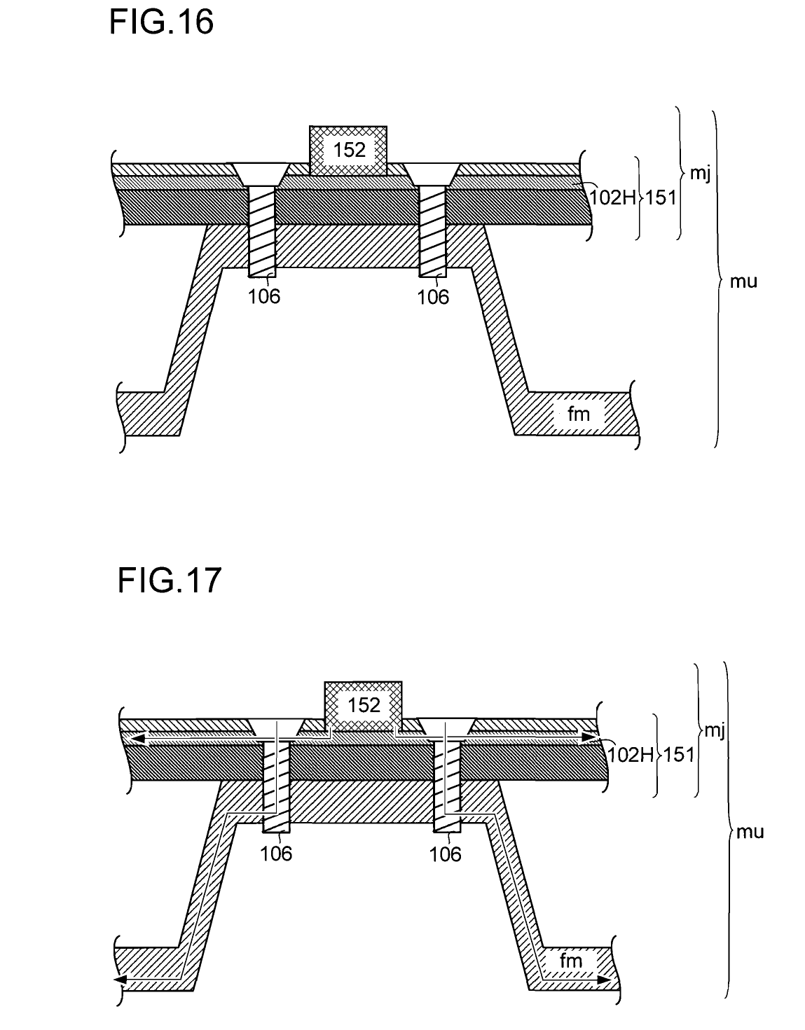

The type of LED 52 is not particularly limited. For example, an LED 52 may be used in which, as shown in the front view of the LED 52 of FIG. 15A, a blue light emitting chip 52 PB, green light emitting chips 52PG and red light emitting chips 52PR are aligned and in which white light is produced by mixing the colors (mixing). An LED 52 may be used in which, as shown in the front view of the LED 52 of FIG. 15B, light from the blue light emitting chip 52 PB is mixed with light emitted from a fluorescent member 50 that is excited by the light from the blue light emitting chip 52 PB, and in which white light is thereby produced (suffixes B, G and R subsequent to the light emitting chip 52P refer to colors).

The light guide plate set ST includes a light guide plate 53 and a reflective sheet 54.

The light guide plate 53 reflects light multiple times that has entered the light guide plate 53, and emits the light to the outside. The light guide plate 53, as shown in FIG. 1 (its details will be described later), includes a light reception portion 53R that receives light and a light emission portion 53S that connects to the light reception portion 53R.

The light reception portion 53R is a plate-shaped member, and includes a cut KC in a side wall. In the cut KC, the bottom KCb thereof is arranged opposite a light emission surface 52L of the LED 52, and a space enough to enclose the LED 52 is included. Hence, when the LED 52 is attached to be placed in the cut KC, the bottom KCb of the cut KC functions as the light receiving surface 53Rs of the light guide plate 53. In the two surfaces between which the side wall of the light reception portion 53R is sandwiched, the surface facing the frame FM is referred to as a bottom surface 53Rb, and the opposite surface of the bottom surface 53Rb is referred to as a top surface 53Ru.

The light emission portion 53S communicates with the light reception portion 53R such that they are side by side; the light emission portion 53S is a plate-shaped member that is located at a position to which the light that has entered the light emission portion 53S travels. The light emission portion 53S has a bottom surface 53Sb that is the same surface as (flush with) the bottom surface 53Rb of the light reception portion 53R, and a top surface 53Su that produces a step with respect to the top surface 53Ru of the light reception portion 53R.

The top surface 53Su of the light emission portion 53S is not parallel to the bottom surface 53Sb; one surface is inclined with respect to the other surface. Specifically, as the light that has entered the light receiving surface 53Rs travels, the bottom surface 53Sb is inclined to approach the top surface 53Su. In other words, as the light that has entered the light receiving surface 53Rs travels, the thickness (distance between the top surface 53Su and the bottom surface 53Sb) of the light emission portion 53S is gradually reduced, and thus the light emission portion 53S is tapered (the light guide plate 53 including the tapered light emission portion 53S is also referred to as a wedge-shaped light guide plate 53).

The light guide plate 53 including the light reception portion 53R and the light emission portion 53S described above receives the light through the light receiving surface 53Rs, reflects the light between the bottom surface 53b (53Rb and 53Sb) and the top surface 53u (53Ru and 53Su) multiple times and emits the light through the top surface 53Su to the outside (the light emitted through the top surface 53Su is referred to as planar light). Depending on an incident angle of the light with respect to the bottom surface 53b, the light may be emitted through the bottom surface 53b.

Hence, in order to avoid the foregoing, the reflective sheet 54 covers the bottom surface 53b of the light guide plate 53, and reflects light leaking through the bottom surface 53b to return it to the inside of the light guide plate 53.

The light guide plate sets ST including the light guide plates 53 and the reflective sheets 54 described above are arranged in a line according to the arrangement of the LEDs 52, which are arranged in a line (along the alignment direction P) in the LED module MJ. Furthermore, the light guide plate sets ST arranged in lines are arranged in an intersection direction Q (for example, a direction perpendicular to the alignment direction P) that intersects the alignment direction P, and thus the light guide plate sets ST are arranged in a matrix.

In particular, when the light guide plate sets ST are aligned along the intersection direction Q as described above, the top surface 53Ru of the light reception portion 53R supports the bottom surface 53Sb of the light emission portion 53S, and the top surfaces 53Su together form the same surface (the top surfaces 53Su are flush with each other). Even when the light guide plate sets ST are aligned along the alignment direction P, the top surfaces 53Su together form the same surface. Consequently, the top surfaces 53Su of the light guide plates 53 are arranged in a matrix, and thereby form a relatively large light emitting surface (the light guide plates 53 that are arranged in a matrix as described above are also referred to as tandem light guide plates 53).

The diffusion sheet 55 is located to cover the top surfaces 53Su of the light guide plates 53 arranged in a matrix, and diffuses planar light from the light guide plates 53 to spread it over the entire liquid crystal display panel 49 (the diffusion sheet 55 and the prism sheets 56 and 57 are also collectively referred to as an optical sheet group 58).

The prism sheets 56 and 57 are optical sheets that include prism shapes, for example, within the surfaces of the sheets and that deflect a light radiation characteristic; they are located to cover the diffusion sheet 55. Hence, the optical sheets 56 and 57 collect the light that travels from the diffusion sheet 55, and enhance brightness. The light that is collected by the prism sheet 56 and diverges intersects the light that is collected by the prism sheet 57 and diverges.

The internal chassis CS is a frame-shaped member that serves as the framework of the backlight unit 59; the internal chassis CS supports the liquid crystal display panel 49, and also presses and holds the light guide plate sets ST and the optical sheet group 58 that are stacked.

The frame FM is a housing that accommodates the various members described above. The shape of the frame FM is not particularly limited. For example, the frame FM may be box-shaped as shown in FIG. 13; the frame FM may be formed in any other shape. The material of the frame FM is not particularly limited; a metal that significantly dissipates heat is often used (here, the frame FM is assumed to be formed of a metal that dissipates heat).

The frame FM stacks the light guide plate sets ST, the diffusion sheet 55 and the prism sheets 56 and 57 in this order, and accommodates them: the direction in which they are stacked is referred to as a stack direction R (the alignment direction P, the intersection direction Q and the stack direction R may be perpendicular to each other).

In the backlight unit 59 described above, the light guide plate 53 converts light from the LED 52 into planar light and emits it; the planar light is emitted as backlight with brightness enhanced by passing the planar light through the optical sheet group 58. Then, the backlight reaches the liquid crystal display panel 49, and the liquid crystal display panel 49 displays an image with the backlight.

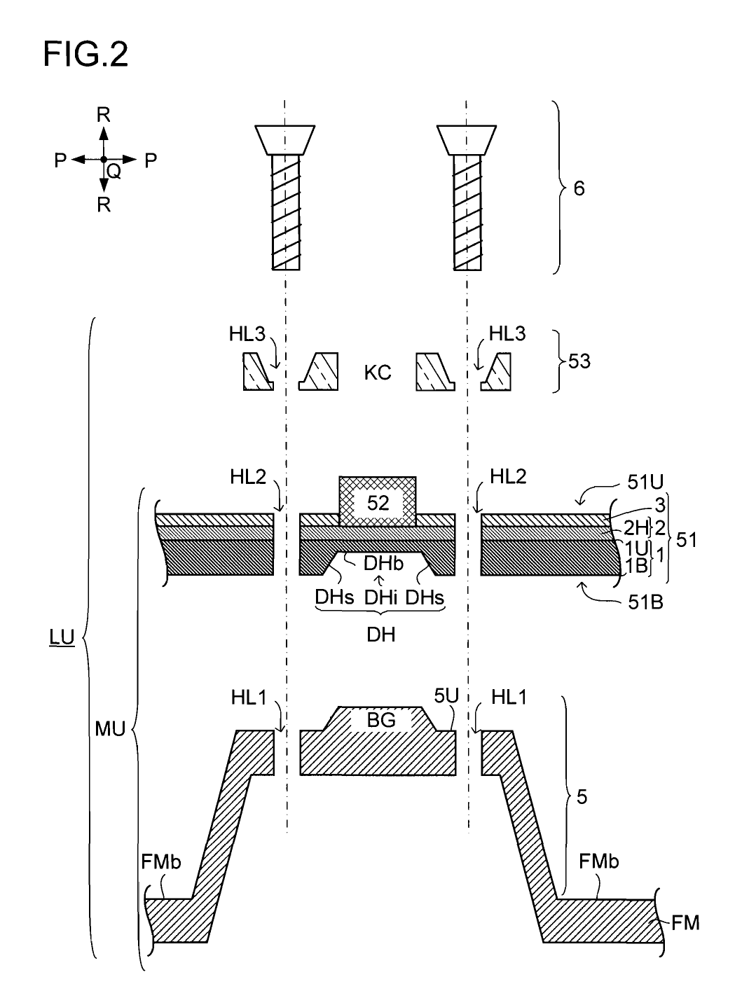

The LED module MJ (particularly the mounting substrate 51) and the frame FM attached to the LED module MJ will now be described with reference to FIG. 1 and FIG. 2 (a cross-sectional view along line B-B′ viewed in the direction of arrows in FIG. 1). In the following description, a unit in which the LED module MJ and the frame FM are integrally formed is referred to as an LED module unit MU.

As shown in FIG. 2, the mounting substrate 51 in the LED module MJ includes a main substrate 1, a wiring pattern 2 and a resist film 3 (for convenience, in FIG. 1, the multi-layer structure of the mounting substrate 51 is shown in a simplified manner).

The main substrate 1 is a member that forms a base body of the mounting substrate 51. The material of the main substrate 1 is not particularly limited. The material may be a flexible material formed of polyimide, polyester or the like; it may be an insulating and hard material such as a glass epoxy (the main substrate 1 formed of a flexible material is referred to as a FPC (flexible printed circuit) substrate; the main substrate 1 formed of an insulating material is also referred to as an insulating substrate).

The wiring pattern 2 includes a supply wiring line (not shown) through which current is passed from an unillustrated power supply and a dissipation wiring line (dissipation pattern) 2H through which current is not passed but heat is particularly dissipated. Both these wiring lines (that is, the wiring pattern 2) are placed over at least one of the opposite surfaces (front substrate surface 1U and back substrate surface 1B) of the main substrate 1 (here, an example of the mounting substrate 51 in which the wiring pattern 2 is placed over the front substrate surface 1U of the main substrate 1 will be described). In order to receive current, the LED 52 is mounted on an electrode connected to the supply wiring line.

The resist film 3 covers the front substrate surface 1U of the main substrate 1, and thereby protects the front substrate surface 1U and the wiring pattern 2 located on the front substrate surface 1U.

The LED module MJ including the mounting substrate 51 (the mounting substrate 51 having the multi-layer structure) described above is attached to a support stage 5 that stands upright on the bottom surface FMb of the frame FM. Specifically, first attachment holes HL1 are formed in the support stage 5, second attachment holes HL2 are formed in the mounting substrate 51 and third attachment holes HL3 are formed in the light guide plate 53; these attachment holes (openings) HL1 to HL3 are stacked and held together with attachment screws (attachment portions) 6. Consequently, the light guide plate set ST and the LED module MJ are attached to the support stage 5 (in short, the attachment screws 6 screw together the light guide plate 53, the mounting substrate 51 and frame FM).

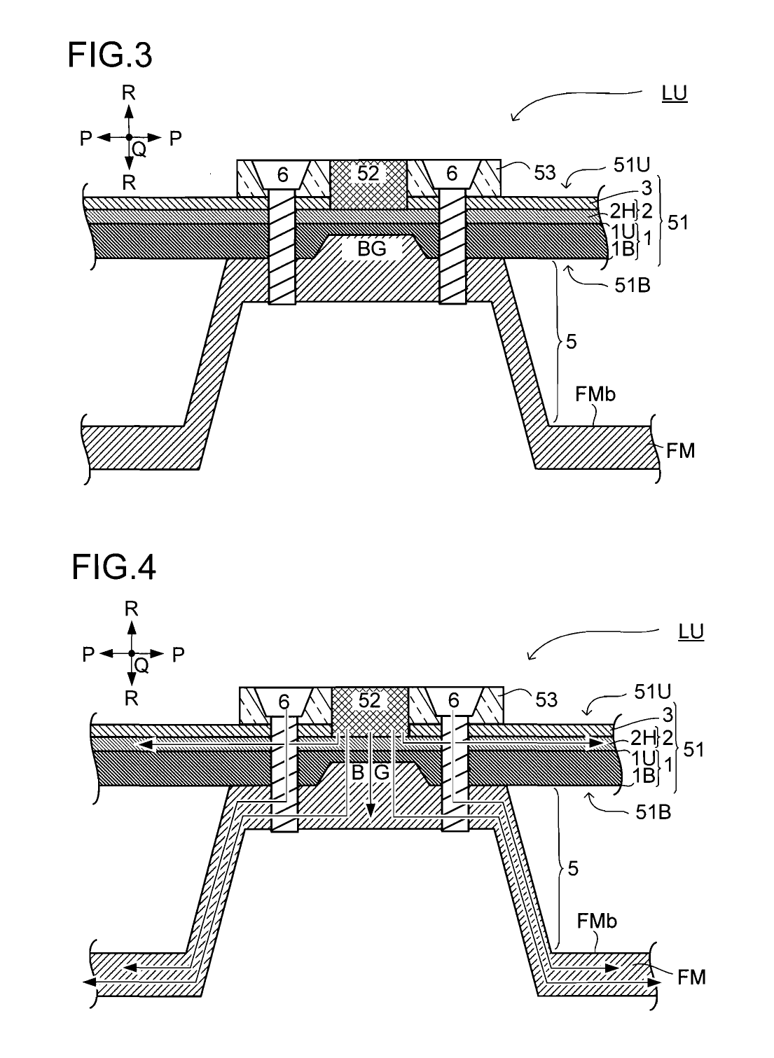

The second attachment holes HL2 are arranged such that the LED 52 is placed therebetween, and correspondingly, the third attachment holes HL3 are arranged such that the cut KC of the light guide plate 53 is placed therebetween. In other words, the attachment holes HL (HL1 to HL3) are aligned along the alignment direction P. Consequently, as shown in FIG. 3 that is a cross-sectional view along the alignment direction P, the support stage 5, the LED module MJ and the light guide plate 53 are stacked in this order and are fixed with the attachment screws 6.

As understood from FIG. 3, the LED module MJ is mounted on the mounting substrate surface 51U (specifically, the front substrate surface 1U of the main substrate 1), and at least part of the non-mounting substrate surface 51B (specifically, the back substrate surface 1B of the main substrate 1) placed under the LED 52 is recessed with respect to the other part of the non-mounting substrate surface 51B. In the recessed portion (recessed portion DH; see FIG. 2) described above, a projection portion BG that projects from the stage surface (supporting surface) 5U of the support stage 5 and that is located between the first attachment holes HL1 is correspondingly arranged.

Specifically, as shown in FIG. 3, when the LED module MJ is attached to the support stage 5, the projection portion BG fits into the recessed portion DH, and the recessed portion DH is filled with the projection portion BG (the unit in which the LED module MJ and the frame FM are integrally formed as described above is referred to as the LED module unit MU). The following is true for the LED module MJ and the frame FM described above (see FIG. 4; arrows indicate heat dissipation paths).

In general, when the LED 52 emits light to produce heat, the heat remains in the LED 52 itself and the mounting substrate 51. However, the LED 52 is located to cover the recessed portion DH. Hence, even in the LED module MJ itself, an area directly below the LED 52 is easily affected by outside air (in short, the LED 52 is easily cooled by outside air) due to the relatively thin recessed portion DH, with the result that the heat that remains in the LED 52 and the mounting substrate 51 is easily dissipated.

When the heat does not remain in the LED 52 as described above, the LED 12 is not degraded, and thus it is possible to achieve prolonged driving (leading to a long life). Moreover, when the LED 52 is not degraded, variations in the brightness and colors of the LEDs 52 in the LED module MJ are reduced. Furthermore, the mounting substrate 11 is not degraded due to the heat, either.

The shape of the recessed portion DH is not particularly limited; the recessed portion DH is preferably tapered toward the bottom DHb (see FIG. 2) of the recessed portion DH (in short, toward the LED 52).

When the recessed portion DH is tapered as described above, the recessed portion DH is formed in the shape of, for example, a frustum (such as a prismoid or a frustum of a cone), and a wall surface DHs joining the bottom DHb directly below the LED 52 extends outward toward an entrance DHi. Hence, the wall surface DHs of the recessed portion DH is increased in area as compared with, for example, the side wall of a recessed portion that is formed in the shape of a column (such as a rectangular parallelepiped, a prism or a cylinder) and that extends with the outside shape of the bottom DHb maintained. Consequently, the recessed portion DH is easily exposed to outside air, and thus the heat that remains in the LED 52 and the mounting substrate 51 is more easily dissipated.

Preferably, in the mounting substrate 51, the second attachment holes HL2, into which the attachment screws 6 fit, are formed in areas adjacent to the LED 52, that is, are formed in areas adjacent to the recessed portion DH. This is because outside air that flows through the second attachment holes HL2 cools the LED 52 from both sides thereof (needless to say, the heat that remains in the LED 52 and the mounting substrate 51 is sufficiently dissipated only in the LED module MJ).

When the LED module MJ described above is attached through the attachment screws 6 to the support stage 5 of the frame FM, the projection portion BG that dissipates heat (and that is made of the same material as the frame FM) is fitted into the recessed portion DH of the mounting substrate 51 (the shape of the projection portion BG is not particularly limited as long as the projection portion BG fills the recessed portion DH). These (the recessed portion DH and the projection portion BG) are in contact with each other. Hence, the heat that remains in the LED 52 and the mounting substrate 51 is dissipated through the recessed portion DH to the projection portion BG. Consequently, the heat is reliably prevented from remaining in the LED 52 and the mounting substrate 51, and thus the LED 12 and the mounting substrate 51 are not degraded.

Since the dissipation wiring line 2H is in contact with the LED 52, the heat that remains in the LED 52 is naturally dissipated through the dissipation wiring line 2H (such heat dissipation is called wiring heat dissipation). Moreover, when the attachment screws 6 are formed of a metal (metallic material) that dissipates a relatively large amount of heat, the heat that remains in the LED 52 and the mounting substrate 51 is dissipated through the attachment screws 6 to the frame FM (such heat dissipation through the attachment screws 6 to the frame FM and through the recessed portion DH to the frame FM is called frame heat dissipation).

In the unit in which the LED module MJ and the frame FM are integrally formed as described above, the heat dissipation through the dissipation wiring line 2H, the heat dissipation through the attachment screws 6 to the frame FM and the heat dissipation through the projection portion BG in contact with the recessed portion DH of the mounting substrate 51 occur, that is, the number of heat dissipation paths is increased. Consequently, the heat that remains in the LED 52 and the mounting substrate 51 is reliably dissipated.

Since the attachment screws 6 that dissipate heat are fitted into the second attachment holes HL2 formed in the areas adjacent to the recessed portion DH of the mounting substrate 51, the attachment screws 6 are arranged near the LED 52 acting as a heat source (specifically, such that the LED 52 is placed between the attachment screws 6). Hence, the heat is efficiently dissipated through the attachment screws 6 to the frame.

Incidentally, the mounting substrate 51 includes the recessed portion DH, and the portions other than the recessed portion DH are relatively thick (in short, are larger in thickness than the recessed portion DH). Hence, the portions of the mounting substrate 51 near the second attachment holes HL2 are relatively thick; those portions are relatively rigid. Even when the LED module MJ and the light guide plate set ST are attached to the frame FM with the attachment screws 6, a load that is caused by the attachment screws 6 and is placed on the mounting substrate 51 does not bend the mounting substrate 51.

When the mounting substrate 51 is not bent (warped) as described above, the bending of the mounting substrate 51 does not cause the LED 52 to be moved, and hence the LED 52 is not displaced with respect to the light guide plate 53. When the LED 52 is not displaced with respect to the light guide plate 53 as described above, a predetermined amount of light from the LED 52 only enters the light guide plate 53 at a predetermined incident angle. Therefore, the backlight from the backlight unit 59 neither causes variations in brightness nor reduces the amount of light.

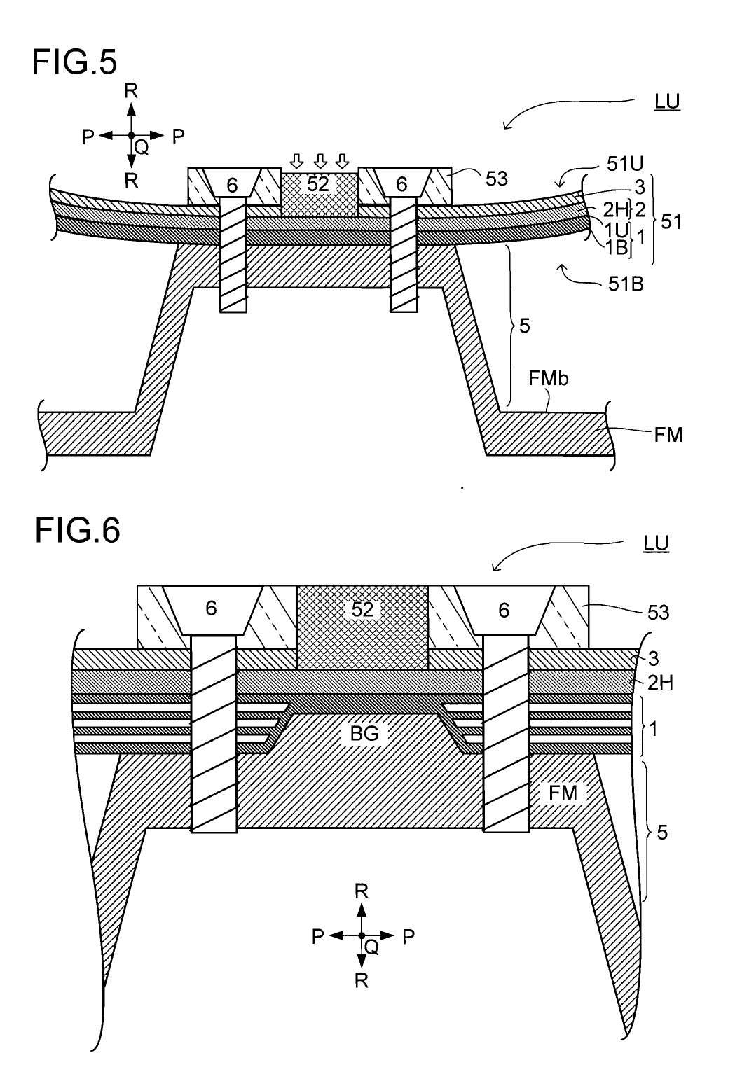

When the mounting substrate 51 is specifically designed for dissipating the heat of the LED 52 and is thus extremely thin, as shown in the cross-sectional view of FIG. 5, a load caused by the attachment screws 6 on the mounting substrate 51 may cause the mounting substrate 51 to be bent, and thus the LED 52 may be displaced with respect to the light guide plate 53 (white arrows indicate the movement of the LED 52). However, the mounting substrate 51 which is shown in FIG. 3 and a portion of which is only thin due to the recessed portion DH is prevented from being bent as shown in FIG. 5.

In order to prevent the mounting substrate 51 from being bent as described above, as shown FIG. 6 that is an enlarged view of FIG. 3, the main substrate 1 may have a multi-layer structure. This is because, when the main substrate 1 has a multi-layer structure, the main substrate 1 is flexible and hence the mounting substrate 51 is more rigid.

### Second Embodiment

A second embodiment will be described. Members that have the same functions as those used in the first embodiment are identified with like symbols, and their description will not be repeated.

In the mounting substrate 51 of the first embodiment, the recessed portion DH is formed in the back substrate surface 1B of the main substrate 1, and the recessed portion DH does not extend from the back substrate surface 1B to the front substrate surface 1U (in short, the recessed portion DH does not penetrate the main substrate 1). However, the mounting substrate 51 is not limited to this configuration.

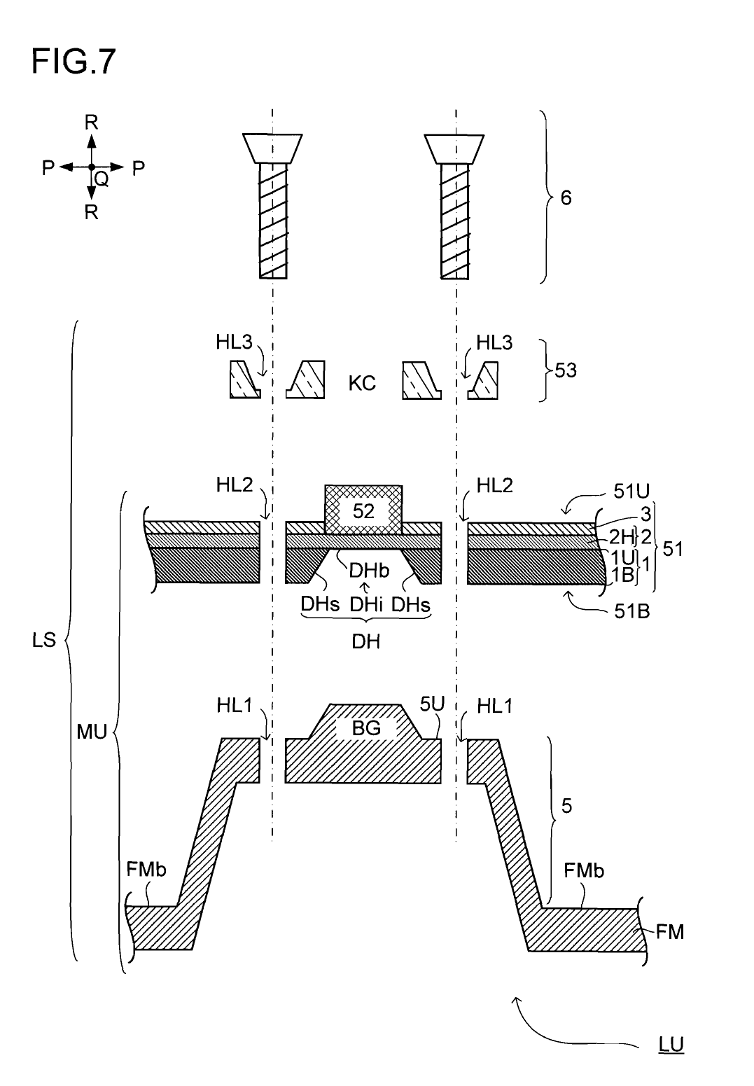

For example, as shown in an exploded cross-sectional view of FIG. 7, the recessed portion DH may penetrate the main substrate 1 from the back substrate surface 1B to the front substrate surface 1U, and the dissipation wiring line 2H may be exposed to the recessed portion DH (in particular, the dissipation wiring line 2H may be exposed from the bottom DHb of the recessed portion DH).

In this configuration, the dissipation wiring line 2H in contact with the LED 52, especially, the portion of the dissipation wiring line 2H directly below the LED 52 is exposed to outside air. Hence, the LED 52 is efficiently cooled by the dissipation wiring line 2H exposed to outside air. In other words, the heat that remains in the LED 52 and the mounting substrate 51 is more easily dissipated.

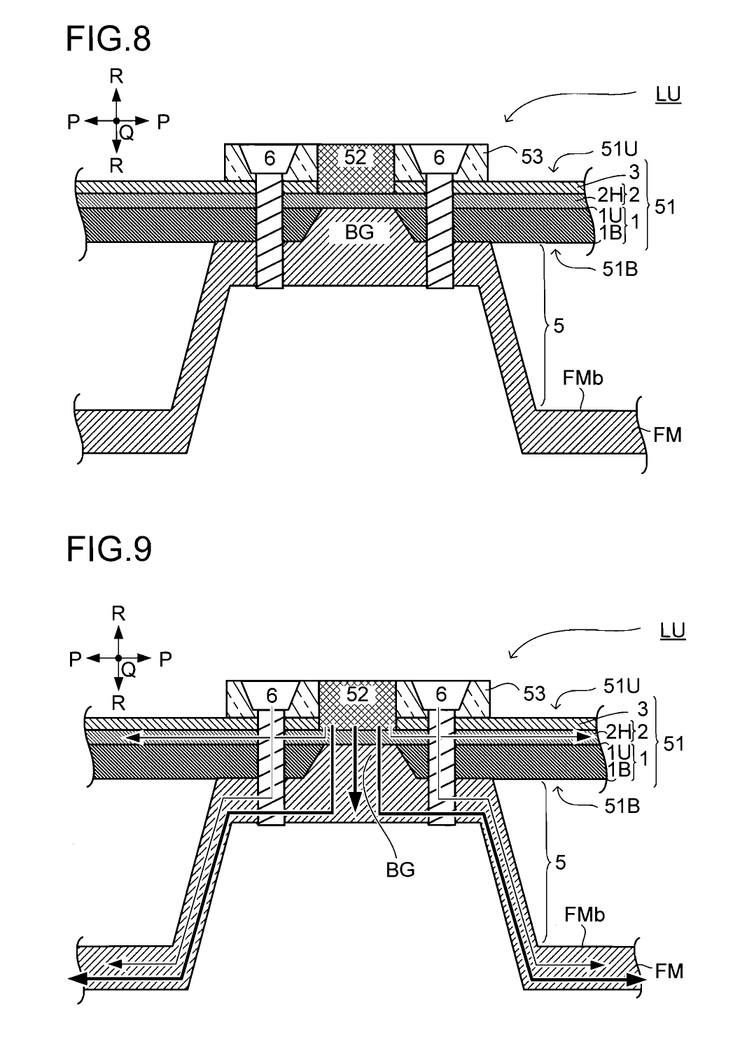

When, as shown in FIG. 8, the LED module MJ and the frame FM are integrally formed, the projection portion BG of the frame FM is fitted into the recessed portion DH to which the dissipation wiring line 2H is exposed. The recessed portion DH and the projection portion BG are in contact with each other. Hence, as shown in FIG. 9, the heat that remains in the LED 52 and the mounting substrate 51 is also dissipated to the projection portion BG through the dissipation wiring line 2H exposed in the recessed portion DH (arrows indicate heat dissipation paths, and the thickness of the arrows increases with the amount of heat dissipated). Therefore, the heat is much further dissipated from the LED 52 and the mounting substrate 51.

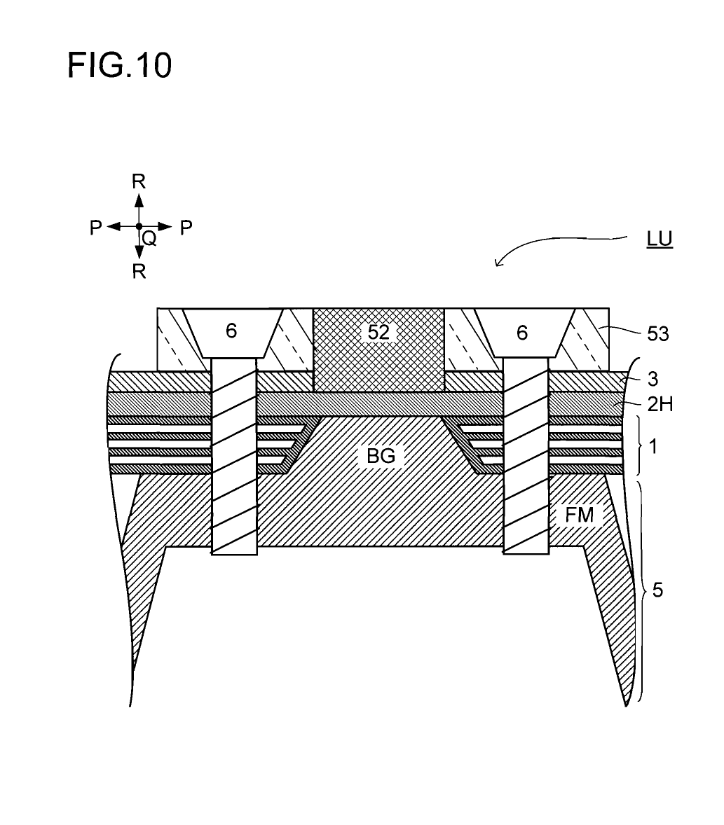

Although the depth of the recessed portion DH in the second embodiment is larger than that of the recessed portion DH in the first embodiment, the portions of the mounting substrate 51 other than the recessed portion DH (specifically, the portions of the main substrate 1 other than the recessed portion DH) can have a thickness equal to or more than a predetermined thickness. Hence, the mounting substrate 51 has a rigidity equal to or more than a predetermined rigidity, and is not bent due to the attachment screws 6. It goes without saying that, as shown in FIG. 10 which is an enlarged view of FIG. 8, the main substrate 1 may have a multi-layer structure.

### Other Embodiments

The present invention is not limited to the above embodiments; many modifications are possible without departing from the spirit of the present invention.

For example, the area of the bottom DHb of the recessed portion DH is not particularly limited. For example, the area of the bottom DHb may be either approximately equal to the area of the LED 52 in contact with the mounting substrate surface 51U or equal to or more than it. The area of the bottom DHb is smaller than that of the LED 52 in contact with the mounting substrate surface 51U (in other words, in the non-mounting substrate surface 51B, at least a portion of the region on which the LED 52 is placed is preferably the recessed portion DH that is recessed with respect to the other portions).

In short, it is preferable that the bottom DHb of the recessed portion DH be located directly below the LED 52 and that the portion directly below the LED 52 is brought close to outside air. This is because, in this configuration, the mounting substrate 51 including the recessed portion DH can efficiently cool the LED 52 as compared with a mounting substrate having a constant thickness (in other words, a mounting substrate having no recessed portion).

When the LED module MJ and the frame FM are integrally formed, the recessed portion DH is filled with the projection portion BG that significantly dissipates heat. Hence, when the bottom DHb of the recessed portion DH directly below the LED 52 is wide, and accordingly the end of the projection portion BG is wide, the heat of the LED 52 is more efficiently dissipated through the projection portion BG to the frame FM.

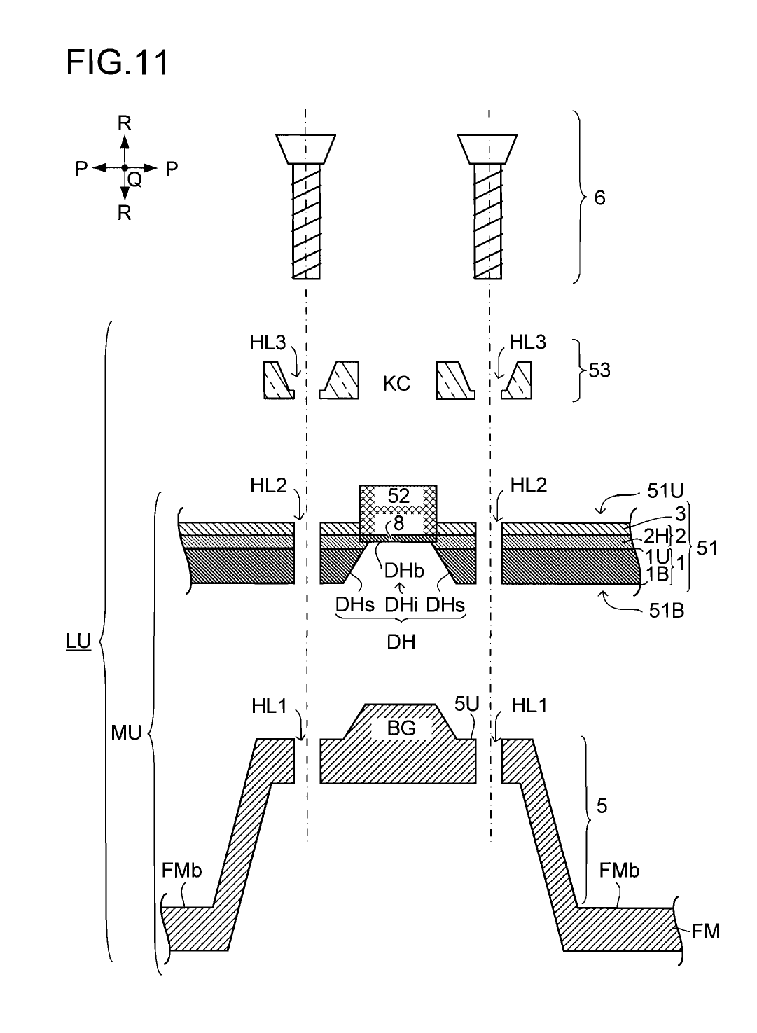

As shown in FIG. 11, the mounting substrate 51 (specifically the main substrate 1) may include, for example, a FPC substrate (thin substrate) 8 that is thinner than the dissipation wiring line 2H. In particular, the dissipation wiring line 2H may be in contact with the LED 52 through the FPC substrate 8, and the FPC substrate 8 and the dissipation wiring line 2H may be exposed to the recessed portion DH.

Even in this configuration, the FPC substrate 8 directly below the LED 52 is exposed to outside air, and thus the LED 52 is cooled. In particular, when the FPC substrate 8 is thinner than the dissipation wiring line 2H (its thickness is shorter than the thickness of the dissipation wiring line 2H), the LED 52 is brought closer to outside air and thus is more efficiently cooled.

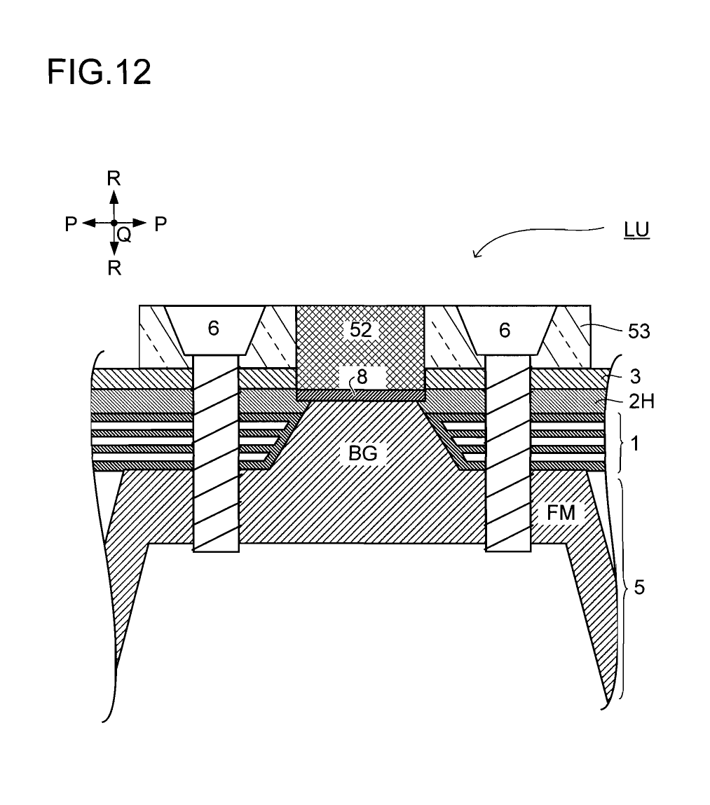

When, as shown in FIG. 12, the LED module MJ is attached through the attachment screws 6 to the support stage of the frame FM, and thus the projection portion BG is fitted into the recessed portion DH to which the FPC substrate 8 and the dissipation wiring line 2H are exposed, the projection portion BG that dissipates heat is in contact with the FPC substrate 8 and the dissipation wiring line 2H. Therefore, the heat is reliably prevented from remaining in the LED 52 and the mounting substrate 51, and is dissipated through the projection portion BG to the frame FM.

Although the light guide plate set ST and the LED module MJ are attached to the frame FM through the attachment screws 6, the present invention is not limited to this configuration. However, when a removable fixture such as the attachment screw 6 is used, the light guide plate set ST and the LED module MJ can easily be removed from the frame FM, and this results in increased convenience. This also makes it possible to dissipate through the attachment screws 6 the heat that remains in the LED 52 and the mounting substrate 51.

Although the above description deals with the case where the recessed portion DH of the mounting substrate 51 is tapered toward the bottom thereof, the projection portion BG of the frame FM is tapered toward the end thereof and they are in intimate contact with each other, the present invention is not limited to this case. In other words, the projection portion BG may be fitted into the recessed portion DH with a gap therebetween (the recessed portion DH and the projection portion BG may be indirectly in contact with each other through outside air).

When, as in the case described above, the recessed portion DH and the projection portion BG are in intimate contact with each other with no gap therebetween, the heat that remains in the LED 52 and the mounting substrate 51 is efficiently dissipated through the projection portion BG to the frame FM.

In the tandem backlight unit 59 described above as an example, the light receiving surface 53Rs receiving light form the LED 52, the top surface 53u (specifically, the top surface 53Su) where light is emitted from one of the two surfaces between which the light receiving surface 53Rs is sandwiched and the bottom surface 53b having the light receiving surface 53Rs sandwiched between the bottom surface 53b and the top surface 53u are included, and a plurality of light guide plates 53 that are tapered by changing the space between the top surface 53u and the bottom surface 53b are arranged in a matrix. When this tandem backlight unit 59 individually controls light emitted by each of the light guide plates 53, the backlight unit 59 is also regarded as an active-area type backlight unit 59 due to the method of controlling the amount of light.

Specifically, in the active-area type backlight unit 59, when the display region of the liquid crystal display panel 49 is divided into a plurality of regions, the divided display regions are brought into correspondence with the individual light guide plates 53, and light is applied from the individual light guide plates 53 to the corresponding divided display regions.

Since the backlight unit 59 described above independently illuminates the divided display regions necessary for the liquid crystal display panel 49, it is possible to reduce power consumption as compared with a backlight unit that illuminates the entire region of the liquid crystal display panel 49 at a time. Moreover, since the amount of light is changed for each of the divided display regions, the display gradation of the liquid crystal display panel 49 has multiple levels (which makes it possible to display high quality images). In particular, when, as shown in FIG. 15A, the LED 52 produces white light by mixing colors, only light of colors corresponding to the divided display regions of the liquid crystal display panel 49 can be emitted, and thus power consumption is reduced, with the result that color enhancement on an image can be performed.

When the active-area type backlight unit 59 described above is designed to have a smaller thickness, the tandem backlight unit 59 is advantageous over a so-called direct-lit backlight unit (a backlight unit incorporating the LED 52 that emits light in a direction substantially perpendicular to the direction of the surface of the liquid crystal display panel 49).

In general, in the direct-lit backlight unit, the light guide plate 53 is omitted, and light from the LED 52 directly enters the optical sheet group 58. If the light does not somewhat diverge before it reaches the optical sheet group 58, the light emanating from the optical sheet group 58 has variations in brightness (or uneven color mixing or the like).

Hence, a relatively long distance between the LED 52 and the optical sheet group 58 is necessary so that the light diverges (in short, a long light path is necessary). Therefore, the direct-lit backlight unit is not suitable for a thin active-area type backlight unit.

However, in the tandem backlight unit 59, the light from the LED 52 enters the side wall of the light guide plate 53 (specifically, the light reception portion 53R) in a direction parallel to the direction of the surface of the liquid crystal display panel 49, and the light is reflected multiple times within the light guide plate 53, with the result that the length of the light path is increased. If the thickness of the light guide plate 53 in the tandem backlight unit 59 is less than the distance between the LED 52 and the optical sheet group 58 in the direct-lit backlight unit, the following is true.

The tandem backlight unit 59 ensures the length of its optical path and thus prevents variations in brightness and the like, and furthermore its thickness is relatively reduced. Moreover, the liquid crystal display device 69 incorporating the backlight unit 59 can provide a high quality image and is thin. Hence, in the thin active-area type backlight unit 59, it is significantly effective to arrange wedge-shaped light guide plates 53 in a tandem configuration.

However, in a thin active-area type and tandem backlight unit 59, a large number of LEDs 52 are mounted, and the light guide plates 53 spaced a significantly short distance away from each other further cover the LEDs 52. Hence the LEDs 52 are arranged in a relatively small space covered by the light guide plates 53, and heat produced by driving of the LEDs 52 easily remains in the small space.

In contrast, since the direct-lit backlight unit has a relatively long distance between the LEDs 52 and the optical sheet group 58, the LEDs 52 are arranged in a relatively large space, and heat produced by driving of the LEDs 52 is unlikely to remain in the space. Therefore, it is highly required to dissipate heat in the thin active-area type and tandem backlight unit 59 as compared with the direct-lit backlight unit.

Consequently, the above-described LED module unit MU (the unit that incorporates the mounting substrate 51 on which the LEDs 52 are mounted and the frame FM) that significantly dissipates heat is extremely effective for the backlight unit 59 described above. Needless to say, the LED module unit MU is also effective for other backlight units.

Although the above description deals with the case where the LED 52 is used as the light-emitting element, the present invention is not limited to this case. For example, a light-emitting element formed of a material, such as an organic EL (electro-luminescence) or an inorganic EL, that spontaneously emits light may be used.

### LIST OF REFERENCE SYMBOLS

1 Main substrate
1U Front substrate surface
1B Back substrate surface
DH Recessed portion
DHb Bottom of the recessed portion
DHs Wall surface of the recessed portion
DHi Entrance of the recessed portion
2 Wiring pattern
2H Dissipation wiring line
3 Resist film
HL2 Second attachment hole (opening)
FM Frame
BG Projection portion
HL1 First attachment hole (opening)
5 Support stage of the frame
5U Stage surface of the support stage (supporting surface)
6 Attachment screw
8 FPC substrate (thin substrate)
49 Liquid crystal display panel
MJ LED module (light-emitting module)
MU LED module unit (light-emitting module unit)
51 Mounting substrate
51U Mounting substrate surface
51B Non-mounting substrate surface
52 LED (light-emitting element)
52P Light-emitting chip
52L Light emission surface
53 Light guide plate
53R Light reception portion (light guide plate)
53Ru Top surface of the light reception portion
53Rb Bottom surface of the light reception portion
53S Light emission portion (light guide plate)
53Su Top surface of the light emission portion
53Sb Bottom surface of the light emission portion
HL3 Third attachment hole (opening)
54 Reflective sheet
ST Light guide plate set
LS Light guide unit
55 Diffusion sheet (optical sheet)
56 Prism sheet (optical sheet)
57 Prism sheet (optical sheet)
58 Optical sheet group
59 Backlight unit

1. A light-emitting module unit comprising:
a light-emitting element that emits light;
a mounting substrate in which the light-emitting element is mounted on a mounting substrate surface that is one of opposite substrate surfaces of the mounting substrate and which includes a recessed portion formed by hollowing at least a part of a region of a non-mounting substrate surface that is the other of the opposite substrate surfaces with respect to the non-mounting substrate, the region being positioned under the light-emitting element; and
a frame that includes a support surface supporting the mounting substrate and a projection portion projecting from the support surface to fill the recessed portion and make contact with the mounting substrate.

2. The light-emitting module unit of claim 1,
wherein the recessed portion is tapered toward a bottom of the recessed portion.

3. The light-emitting module unit of claim 2,
wherein the projection portion is tapered toward an end of the projection portion, and the recessed portion and the projection portion are in intimate contact with each other.

4. The light-emitting module unit of claim 1,
wherein the mounting substrate includes a heat dissipation wiring line in contact with the light-emitting element, and the heat dissipation wiring line is exposed to the recessed portion.

5. The light-emitting module unit of claim 1,
wherein a main substrate that forms a base body of the mounting substrate has a multi-layer structure.

6. The light-emitting module unit of claim 1,
wherein openings that penetrate the mounting substrate are formed in areas adjacent to the recessed portion.

7. The light-emitting module unit of claim 6,
wherein attachment portions formed of a heat dissipation material are fitted into the openings, and the mounting substrate is fixed to the frame with the attachment portions.

8. A light guide unit comprising:
he light-emitting module unit of claim 7; and
a light guide plate that receives light from the light-emitting element,
wherein the light guide plate is fixed to the light-emitting module with the attachment portions.

9. The light guide unit of claim 8,
wherein an equal or greater number of the light guide plates than a number of the light-emitting elements are included and are arranged to form a substrate.

10. The light guide unit of claim 9,
wherein the light guide plate includes: a light receiving surface that receives light from the light-emitting element; a light emitting surface that is one of two surfaces between which the light receiving surface is sandwiched and that emits light; and a bottom surface having the light receiving surface sandwiched between the light emitting surface and the bottom surface,
the light guide plate is tapered and wedge-shaped by changing a distance between the light emitting surface and the bottom surface, and
the light guide plates are arranged in a matrix.

11. A backlight unit comprising:
the light guide unit of claim 8; and
an optical sheet that receives light guided by the light guide plate.

12. A liquid crystal display device comprising:
the backlight unit of claim 11; and
a liquid crystal display panel that receives light from the backlight unit.

13. A backlight unit comprising:
the light guide unit of claim 9; and
an optical sheet that receives light guided by the light guide plate.

14. A liquid crystal display device comprising:
the backlight unit of claim 13; and
a liquid crystal display panel that receives light from the backlight unit.

15. A backlight unit comprising:
the light guide unit of claim 10; and
an optical sheet that receives light guided by the light guide plate.

16. A liquid crystal display device comprising:
the backlight unit of claim 15; and
a liquid crystal display panel that receives light from the backlight unit.
